(19) United States
(12) Patent Application Publication
(10) Pub. No.: US 2009/0163649 A1
(43) Pub. Date: Jun. 25, 2009

(54) One-Part Type Heat Curable Composition

(75) Inventors: Toshihide Sasaki, Kanagawa (JP); Akira Sugiyama, Hiratsaku-shi (JP)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/223,661

(22) PCT Filed: Feb. 9, 2007
(86) PCT No.: PCT/EP2007/051238

§ 371 Date: Feb. 2, 2009

(30) Foreign Application Priority Data
Feb. 9, 2006 (JP) 2006-032768

(51) Int. Cl. C09J 175/04

(52) U.S. Cl. 524/589

(57) ABSTRACT

To provide a one-part type heat curable composition which exhibits superior adhesion properties, is easily cured by heating, does not soften even if the composition is baked at increased temperature, is completely cured by means of moisture in the atmosphere even if curing is not sufficient due to heating temperature, heating period, and the like, and exhibits increased adhesiveness with respect to a coating film after the composition is cured. A one-part type heat curable composition comprising: (A) a prepolymer having a urethane bond(s), and an isocyanate group(s) at a chain end or pendent position(s) thereof; (B) an amine-adduct type latent hardener; and (C) a moisture latent hardener.

### FIELD OF THE TECHNOLOGY

The present invention relates to a one-part type heat-curable composition which is easily cured by means of heat, exhibits superior adhesion properties, is not softened during baking at increased temperature, can be completely cured by means of moisture in the atmosphere even if heat curing is not sufficient, and can be easily coated.

### BACKGROUND ART

Conventionally, heat-curable sealing products have been used in order to maintain airtight properties and water-tight properties by sealing junction parts or void parts when press molded steel plates are assembled by means of partial welding such as spot welding in the manufacturing lines of automobiles, refrigerators, and the like. The structures assembled by partial welding such as spot welding are subjected to electrophoretic coating in order to prevent rusting, and subsequently, a heat-curable sealing product is applied to specified parts. Subsequently, undercoating, medium coat, and finishing coating paints are baked thereon for aesthetic purposes, if necessary. By the heat during the aforementioned baking paint, the sealing product is cured. For the aforementioned use, measuring or mixing is not necessary, and a one-part type heat-curable sealing product is suitable.

As the one-part type heat-curable sealing product, conventionally, a polyvinyl chloride (PVC) paste composition, which is the so-called PVC plastisol-based sealing product, is employed, in which powders of a PVC are dispersed in a plasticizer, and an adhesion agent, a stabilizer, a filler, and the like are blended. However, the polyvinyl chloride causes an occurrence of dioxin and the like during burning. For this reason, development of alternatives is desirable. For example, acryl sol-based or urethane-based sealing products have been actively studied recently (for example, see Japanese Unexamined Patent Application, First Publication No. H10-158353).

However, in the case of using a one-type heat-curable urethane composition as a sealing product, since a heat curable urethane composition has a property of softening at the time of baking at increased temperatures such as about 160° C., another heat curable urethane composition is desirable in which the composition is easily cured by heating, exhibits superior adhesion properties, and does not soften even if the composition is baked at increased temperature. In addition, a sealing product which can also be useful even if curing is not sufficient due to heating temperature, heating period, and the like is desirable. In addition, in the case of coating the sealing product, it is necessary to exhibit good adhesiveness between the coating film and the cured urethane composition.

### DISCLOSURE OF THE INVENTION

### Problems to be Solved by the Invention

The present invention intends to meet the aforementioned demand. More particularly, the present invention has an objective to provide a one-part type heat-curable composition which exhibits superior adhesion properties, is easily cured by heating, does not soften even if the composition is baked at increased temperature, is completely cured by means of moisture in the atmosphere even if curing is not sufficient due to heating temperature, heating period, and the like, and exhibits increased adhesiveness with respect to a coating film after the composition is cured.

### Means for Solving the Problems

The objective of the present invention can be achieved by a one-part type heat-curable composition comprising:
(A) a prepolymer having a urethane bond(s), and an isocyanate group(s) at a chain end(s) or a pendent position(s) thereof;
(B) an amine-adduct type latent hardener; and
(C) a moisture latent hardener.

The aforementioned prepolymer (A) preferably has a polyether structure(s).

The aforementioned prepolymer (A) can be included in a range of from 15 to 80% by weight based on the total weight of the composition.

The aforementioned amine-adduct type latent hardener (B) can be included in a range of from 0.1 to 10% by weight based on the total weight of the composition.

The aforementioned moisture latent hardener (C) can be included in a range of from 0.1 to 10% by weight based on the total weight of the composition.

The one-part type heat-curable composition of the present invention can be employed as a main component of a sealing product or an adhesive.

### EFFECTS OF THE INVENTION

According to the present invention, a one-part type heat-curable composition can be provided, which exhibits superior adhesion properties, is easily cured by heating, does not soften when the composition is baked at increased temperature, and exhibits increased adhesiveness with respect to a coating film after the composition is cured.

### BEST MODES FOR CARRYING OUT THE INVENTION

The structure of the aforementioned prepolymer (A) having a urethane bond(s), and an isocyanate group(s) at a chain end(s) or a pendent position(s) thereof, which is one of the essential components of the composition according to the present invention, is not particularly limited. It is preferable that a urethane bond(s) be contained in the linear main skeleton, and an isocyanate group(s) be contained at a chain end position(s) of the molecule, and in particular, at the two chain end positions. The aforementioned prepolymer (A) can be included in a range of from 15 to 80% by weight, preferably in a range of from 30 to 70% by weight, and more preferably in a range of from 40 to 60% by weight, based on the total weight of the composition.

The aforementioned prepolymer (A) can be prepared by, for example, reacting a polyisocyanate component and a polyol component. The aforementioned polyisocyanate component preferably contains an NCO (isocyanate) group in an amount ranging from 20% to 60%. The aforementioned polyisocyanate component can be any one of aliphatic, alicyclic, and/or aromatic polyisocyanates.

As preferable examples of the polyisocyanate components, mention may be made of toluene diisocyanate (TDI); diphenylmethane diisocyanate (MDI); triphenylmethane triisocyanate; diphenylsulfone diisocyanate; 3,3′-dimethyl-4,4′-biphenylene diisocyanate; 1,4-phenylene diisocyanate; xylene diisocyanate (XDI); tetramethylxylene diisocyanate (TMXDI); naphthylene diisocyanate; norbornane diisocyanate (NBDI); bis-(4-isocyanatecyclohexyl)methane; crude TDI; polymethylene/polyphenyl isocyanate (polymeric MDI); 1-isocyanate-3,3,5-trimethyl-5-isocyanate methylcyclohexane (isophorone diisocyanate ═IPDI); ethylene diisocyanate; propylene diisocyanate; hexamethylene diisocyanate (HDI); 1,4-tetramethylene diisocyanate; 1,5-pentamethylene diisocyanate; 2,2,4-trimethyl-1,6-hexamethylene diisocyanate; 1-isocyanate-1-methyl-4(3)-isocyanate-methylcyclohexane; hydrogenated xylene diisocyanate; 1,3-diisocyanate-6-methylcyclohexane; 1,3-diisocyanate-2-methylcyclohexane; dicyclohexylmethane diisocyanate; and isomers thereof. In addition, dimmers thereof (for example, urethodione diisocyanate) or trimers (for example, isocyanulate triisocyanate), and the like, may be mentioned. In addition, the isocyanulate products, carbodiimide products, and biuret products thereof can also be employed. In addition, mixtures thereof can also be employed. Among these, isophorone diisocyanate (IPDI), toluene diisocyanate (TDI), and a mixture thereof are, in particular, preferable.

The aforementioned polyol component, which is a diol or a triol, or a mixture thereof, preferably has an average molecular weight ranging from 2,000 to 20,000 (corresponding to the OH value ranging from 56 to 5.6), and preferably ranging from 3,000 to 12,000 (corresponding to the OH value ranging from 42 to 7.4). As examples of the polyol component, mention may be made of, for example, ethylene glycol, propylene glycol, butylene glycol, hexylene glycol, glycerol, trimethylolpropane, pentaerythritol, sorbitol, sugar alcohol, and oligoglycols thereof, as well as mixtures thereof.

The aforementioned polyol component preferably contains a polyether structure(s). As examples of the polyol having a polyether structure(s), mention may be made of, for example, a polyoxyalkylenediol. As the polyoxyalkylenediol, diols which are known in the field of polyurethane chemistry can be employed. For example, the polyoxyalkenediol can be produced by alkoxylation such as ethoxylation or propoxylation of a diol having an appropriate starting molecular weight. As examples of the diol, mention may be made of ethylene glycol, propylene glycol, 1,3-butanediol, 1,4-butanediol, 1,6-hexanediol, 2-ethyl-1,3-hexanediol, and the like, as well as mixtures thereof. As the polyoxyalkylenediol, in particular, polyethylene glycol, polypropylene glycol, and polybutylene glycol are preferable.

The aforementioned polyoxyalkylenediol can also be produced by alkoxylation of an alkylene oxide. As examples of the preferable alkylene oxide, mention may be made of ethylene oxide, propylene oxide, and mixtures thereof. As examples of the alcohol which can be employed in the alkoxylation, mention may be made of, for example, ethylene glycol, propylene glycol, glycerol, trimethylolpropane, and polyhydric alcohols such as pentaerythritol, sorbitol, sucrose, and the like.

The aforementioned polyol component can also be produced by alkoxylation of an aliphatic amine having at least two N—H bonds. As examples of the aforementioned aliphatic amine, mention may be made of ethylamine, butylamine, and the like.

In addition, the aforementioned polyol component can be prepared from an alcohol having a low molecular weight and a polybasic carboxylic acid such as adipic acid, sebacic acid, phthalic acid, isophthalic acid, tetrahydrophthalic acid, hexahydrophthalic acid, maleic acid, anhydrides thereof, and mixtures thereof. For example, polyester polyols such as polyethylene adipate and the like may be mentioned. As the polyol component, polylactones having hydroxyl groups (in particular, poly-ε-caprolactone polyol) are also preferable. In addition, polybutadiene polyols and higher fatty acid esters having hydroxyl groups such as castor oil and the like can also be employed as the polyol component.

In addition, as the aforementioned polyol component, a polymer having plural hydroxy groups, such as polyvinyl alcohol and the like can also be employed. As the polymer having plural hydroxy groups, a polymer polyol in which vinyl monomers are grafted on a polyester polyol and a polycarbonate having hydroxyl groups can also be employed.

The aforementioned prepolymer (A) can be produced by reacting the polyisocyanate component and the polyol component at a temperature ranging from 40 to 120° C., and preferably ranging from 50 to 100° C. so that the NCO/OH equivalent ratio ranges from 1.3:1 to 20:1, and preferably ranges from 1.4:1 to 10:1. In the case of carrying out a chain extension via a urethane group during producing the first compound, the NCO/OH equivalent ratio is preferably selected from the range of from 1.3:1 to 2:1. In the case of not desiring the chain extension, a polyisocyanate component in excessive amounts is preferably employed, and for example, a NCO/OH equivalent ratio ranging from 4:1 to 20:1, and preferably ranging from 5:1 to 10:1 is employed. The diisocyanate in excessive amounts can be removed by, for example, distillation, after the completion of the reaction. A known catalyst such as an organic metal catalyst or an amine can be employed in the preparation of the aforementioned prepolymer (A), if necessary.

The aforementioned amine-adduct type latent hardener (B), which is another essential component of the composition according to the present invention, is generally present in the form of a powder or a microcapsule. At around room temperature, a chemical reaction between the hardener and the prepolymer (A) is controlled, but by means of heating, the hardener is dissolved, and the chemical reaction with the prepolymer (A) is started. The aforementioned amine-adduct type latent hardener (B) is in the form of a powder, and functions as a curing agent by heating to 70° C. or more.

As examples of the aforementioned amine-adduct type latent hardener (B), mention may be made of a reaction product between an amine compound and an epoxy compound (amine-epoxy adduct-based product), a reaction product between an amine compound and an isocyanate compound or a urea compound (urea type adduct-based product), and the like, as well as, surface-treated hardeners in which the surface of the aforementioned hardeners (reaction products) is treated with an isocyanate compound or an acidic compound. Among these, the amine-epoxy adduct-based hardeners are preferable. The aforementioned amine-adduct type latent hardener (B) can be included in a range of from 0.1 to 10% by weight, preferably in a range of from 0.2 to 6% by weight, more preferably in a range of from 0.5 to 4% by weight, and further preferably in a range of from 1 to 3% by weight, based on the total weight of the composition.

As examples of the aforementioned amine compound, mention may be made of aliphatic polyamines such as ethylenediamine, diethylenetriamine, triethylenetetramine, tetraethylenepentamine, and the like; alicyclic polyamines such as isophoronediamine, menthenediamine, bis(4-amino-3-methyldicyclohexyl)methane, diaminodicyclohexylmethane, bis(aminomethyl)cyclohexane, N-aminoethylpiperadine, 3,9-bis(3-aminopropyl)-2,4,8,10-tetraoxaspiro(5.5)undecane, and the like; mononuclear polyamines such as m-phenylenediamine, p-phenylenediamine, tolylene-2,4-diamine, tolylene-2,6-diamine, mesitylene-2,4-diamine, mesitylene-2,6-diamine, 3,5-diethyltolylene-2,4-diamine, 3,5-diethyltolylene-2,6-diamine, and the like; aromatic polyamines such as biphenylenediamine, 4,4′-diaminodiphenylmethane, 2,5-naphthylenediamine, 2,6-naphthylenediamine; and the like.

As examples of the aforementioned epoxy compounds, mention may be made of, for example, polyglycidyl ether compounds of mononuclear polyhydric phenol compounds such as hydroquinone, resorcinol, pyrocatechol, fluoroglucinol, and the like; polyglycidyl ether compounds of polynuclear polyhydric phenol compounds such as dihydroxynaphthalene, biphenol, methylene bisphenol (bisphenol F), methylene bis(orthocresol), ethylidene bisphenol, isopropylidene bisphenol (bisphenol A), isopropylidene bis(orthocresol), tetrabromobisphenol A, 1,3-bis(4-hydroxycumylbenzene), 1,4-bis(4-hydroxycumylbenzene), 1,1,3-tris(4-hydroxyphenyl)butane, 1,1,2,2-tetra(4-hydroxyphenyl)ethane, thiobisphenol, sulfobisphenol, oxybisphenol, phenol novolak, orthocresol novolak, ethylphenol novolak, butylphenol novolak, octylphenol novolak, resorcinol novolak, terpenephenol, phenolated bicyclopentadiene, and the like; polyglycidyl ethers of polyhydric alcohols such as ethylene glycol, propylene glycol, butylene glycol, hexanediol, polyglycol, thiodiglycol, glycerol, trimethylolpropane, pentaerythritol, sorbitol, bisphenol A-ethylene oxide adducts, and the like; homopolymers or copolymers of glycidyl methacrylate and glycidyl esters of aliphatic, aromatic, or alicyclic polybasic acids such as maleic acid, fumaric acid, itaconic acid, succinic acid, glutaric acid, suberic acid, adipic acid, azelaic acid, sebacic acid, dimer acid, trimer acid, phthalic acid, isophthalic acid, terephthalic acid, trimellitic acid, trimesic acid, pyromellitic acid, tetrahydrophthalic acid, hexahydrophthalic acid, endomethylene tetrahydrophthalic acid, and the like; epoxy compounds having glycidylamino groups such as N,N-diglycidylaniline, bis(4-(N-methyl-N-glycidylamino)phenyl)methane, and the like; epoxylated products of cyclic olefin compounds such as vinylcyclohexene diepoxide, dicyclopentanediene diepoxide, 3,4-epoxycyclohexylmethyl-3,4-epoxycyclohexanecarboxylate, 3,4-epoxy-6-methylcyclohexylmethyl-6-methylcyclohexanecarboxylate, bis(3,4-epoxy-6-methylcyclohexylmethyl)adipate, and the like; epoxylated conjugated diene polymers such as epoxylated polybutadiene, epoxylated styrene-butadiene copolymer, and the like; and heterocyclic compounds such as triglycidyl isocyanulate, and the like. Among these polyepoxy compounds, polyglycidyl ether compounds of bisphenol are preferable.

As examples of the aforementioned isocyanate compound, mention may be made of aliphatic, alicyclic, and aromatic polyisocyanates, such as 2,4-toluene diisocyanate, 2,6-toluene diisocyanate, 4,4′-diphenylmethane diisocyanate, phenylene diisocyanate, xylene diisocyanate, tetramethylxylene diisocyanate, tetramethylene diisocyanate, hexamethylene diisocyanate, lysine diisocyanate ester, 1,4-cyclohexylene diisocyanate, 4,4′-dicyclohexylmethane diisocyanate, 3,3′-dimethoxy-4,4′-biphenylene diisocyanate, 1,5-naphthalene diisocyanate, 1,5-tetrahydronaphthalene diisocyanate, isophorone diisocyanate, and the like.

As examples of representative commercially available products for use as the aforementioned amine-adduct type latent hardener (B), mention may be made of, for example, Amicure MY-24 (produced by Ajinomoto Co., Inc.), Adeka Hardener EH-3615S (produced by Asahi Denka Corporation), Adeka Hardener EH-4070S (produced by Asahi Denka Corporation), Novacure HX-3721 (produced by Asahi Kasei Corporation), Novacure HX-3742 (produced by Asahi Kasei Corporation), and the like. Among these, Adeka Hardener EH-4070S, which is an amine-adduct type latent hardener comprising polyamines, phenols, and epoxy resins, is preferable. In general, Adeka Hardener EH-4070S is employed as a curing agent for use in epoxy resins.

The aforementioned moisture latent hardener (C), which is one of the essential components of the composition of the present invention, produces an amine by means of hydrolysis due to moisture under the usage atmosphere. As examples thereof, mention may be made of, for example, enamines (GB Patent No. 1575666), polyaldimines or polyketimines (GB Patent No. 1064841, DE Patent No. 3133769, Japanese Unexamined Patent Application, First Publication No. H02-283710, and Japanese Unexamined Patent Application, First Publication No. H04-279620), β-lactams (Japanese Unexamined Patent Application, First Publication No. H02-168), oxazolidines (Japanese Unexamined Patent Application, First Publication No. H02-55715), and the like. The blending amount of the aforementioned moisture latent hardener (C) can be in the range of from 0.1 to 10% by weight, preferably in the range of from 0.1 to 6% by weight, more preferably in the range of from 0.1 to 4% by weight, and further preferably in the range of from 0.1 to 2% by weight, on the basis of the total weight of the composition.

In particular, as the aforementioned moisture latent hardener (C), the polyaldimines disclosed in Japanese Unexamined Patent Application, First Publication No. H04-279620, represented by a general formula described below:

Y—(—N═CH—X)ₙ

wherein
X represents an aryl group having 6 to 15 carbon atoms, and plural Xs may be the same or different;
Y represents a divalent or trivalent hydrocarbon group having 2 to 15 carbon atoms, or a divalent or trivalent polyoxyalkylene group having a molecular weight ranging from 70 to 6,000, are preferable.

As the aforementioned aryl group, for example, a phenyl group and a substituted phenyl group having one or more substituents are preferable. As the substituents in the aforementioned case, an alkyl group having 1 to 9 carbon atoms, an alkoxy group having 1 to 9 carbon atoms, and the like are preferable. The number of the substituents of the aforementioned aryl group preferably ranges from 1 to 3. As examples of the aryl group represented by X, mention may be made of, for example, a phenyl group, a methylphenyl group, an ethylphenyl group, a propylphenyl group, a butylphenyl group, a dimethylphenyl group, a methoxyphenyl group, an ethoxyphenyl group, a propoxyphenyl group, and the like.

As the aforementioned hydrocarbon group, a group based on a chain, branched, or cyclic alkyl group is preferable. As the chain alkyl group, groups having 4 to 8 carbon atoms are preferable, as the branched alkyl group, groups having 4 to 10 carbon atoms are preferable, and as the cyclic alkyl group, groups having 1 to 3 rings and having 5 to 12 carbon atoms for the ring are preferable. In addition, the aforementioned ring part may have a substituent. As the substituent, a C₁₋₆ alkyl group such as a methyl group, an ethyl group, a propyl group, and the like is preferable.

As examples of the polyoxyalkylene group in the case of n=2, mention may be made of, for example, the groups obtained by a method in which an alkylene oxide such as ethylene oxide, propylene oxide, or the like is addition-polymerized to a divalent alcohol or water. As examples of the divalent alcohol, mention may be made of, for example, ethylene glycol, propylene glycol, and the like. As examples of the polyoxyalkylene group in the case of n=3, mention may be made of, for example, the groups obtained by a method in which an alkylene oxide such as ethylene oxide, propylene oxide, or the like is addition-polymerized to a trivalent alcohol. As examples of the trivalent alcohol, mention may be made of, for example, glycerol, trimethylolpropane, and the like.

As examples of representative commercially available products which can be employed as the aforementioned moisture latent hardener (C), mention may be made of, for example, ALD-1 produced by Mitsui Takeda Chemicals Inc., which comprises polyaldimines, and the like.

The one-part type heat-curable composition of the present invention can appropriately contain, in addition to the aforementioned components, additives such as fillers, plasticizers, thixotropy agents, solvents, pigments, coupling agents, curing catalysts, moisture-absorbing agents (dehydrating agents), stabilizers, and the like, within a range which does not impair the objective of the present invention. The blending amount of the additives can range, for example, from 1 to 80% by weight, and preferably range from 1 to 60% by weight on the basis of the total weight of the composition.

As examples of the filler, mention may be made of, for example, heavy calcium carbonate, light calcium carbonate, colloidal calcium carbonate, kaolin, talc, silica, titanium oxide, aluminum silicate, magnesium oxide, zinc oxide, carbon black, glass balloon, plastic balloon, diatomaceous earth, zeolite, and the like. The aforementioned filler may be employed alone, or in combination with two or more types thereof.

As examples of the plasticizer, mention may be made of, for example, dioctyl phthalate (DOP), dibutyl phthalate (DBP), dilauryl phthalate (DLP), butylbenzyl phthalate (BBP), diisodecyl phthalate (DIDP), diisononyl phthalate (DINP), dioctyl adipate (DOA), diisononyl adipate (DINA), diisodecyl adipate, trioctyl phosphate, tris(chloroethyl) phosphate, tributyl trimellitate (TBTM), phenyl ester of alkylsulfonic acid, polyester of propylene glycol and adipic acid, polyester of butylene glycol and adipic acid, alkyl epoxy stearate, epoxylated soybean oil, and the like. The aforementioned plasticizer may be employed alone, or in combination with two or more types thereof.

As examples of the thixotropy agent (agent for imparting thixotropic properties), mention may be made of, for example, colloidal silica, hydrogenated castor oil, organic bentonite, tribenzylidene sorbitol, surface-treated precipitated calcium carbonate, fatty acid amide wax, polyethylene wax, a polyurea compound, and the like. The aforementioned thixotropy agent may be employed alone, or in combination with two or more types thereof.

The solvent can be added in order to adjust operationability. As examples thereof, mention may be made of, for example, aromatic hydrocarbons, mineral spirits, methyl ethyl ketone, and the like. The aforementioned solvent may be employed alone, or in combination with two or more types thereof.

As examples of the pigment, mention may be made of iron oxide, carbon black, phthalocyanine blue, phthalocyanine green, and the like. The aforementioned pigment may be employed alone, or in combination with two or more types thereof.

As examples of the coupling agent, mention may be made of, for example, N-(β-aminoethyl)-γ-aminopropylmethyldimethoxysilane, γ-aminopropylmethyltrimethoxysilane, γ-aminopropylmethyltriethoxysilane, vinyltrimethoxysilane, γ-glycidoxypropylmethyltrimethoxysilane, N-(β-aminoethyl)-γ-aminopropylmethyltrimethoxysilane, and the like. In addition, reaction products of two or more types of coupling agents such as aminosilane, epoxysilane, and the like (such as reaction products of various aminosilanes and epoxysilanes, and condensation reaction products of coupling agents having two or more molecules with alkoxy groups) may be mentioned. The aforementioned coupling agent may be employed alone, or in combination with two or more types thereof.

As examples of the curing catalyst, mention may be made of, for example, tertiary amines such as N-methylmorpholine, triethylamine, N,N,N′,N′-tetramethylpropanediamine, bis(2-dimethylaminoethyl)ether, and the like; and organic metal compounds such as dibutyl tin dilaurate, bismuth octate, and the like.

As examples of the moisture absorbing agent, mention may be made of, for example, silane compounds such as vinyl trimethoxysilane, dimethyldimethoxysilane, tetraethoxysilane, methyltrimethoxysilane, methyltriethoxysilane, and the like, and isocyanate compounds such as octadecyl isocyanate, 4,4′-diphenylmethane diisocyanate, isophorone diisocyanate, 4,4′-dicyclohexylmethane diisocyanate, m-tetramethylxylylene diisocyanate, p-tetramethylxylylene diisocyanate, lysine ester triisocyanate, 1,8-diisocyanate-4-isocyanateoctane, and the like. The aforementioned moisture absorbing agent can be employed alone or in combination with two or more types thereof.

As examples of the stabilizer, mention may be made of, for example, known UV absorbing agents such as benzotriazole type, benzophenone type, and the like, antioxidants, optical stabilizers of hindered amine type, and other radical stabilizers. Among these, the benzotriazole type UV absorbing agents are preferable since high UV absorbing performance is exhibited. The aforementioned stabilizer can be employed alone or in combination with two or more types thereof.

In the one-part type heat-curable composition of the present invention, in addition to the aforementioned components, various additives such as antioxidants, antistatic agents, flame retardants, dispersants, and the like can be blended.

The one-part type heat-curable composition of the present invention can be produced by means of a known method under conditions in which the effects of moisture are controlled as much as possible (for example, under vacuum). For example, the aforementioned prepolymer (A) is mixed and stirred together with various fillers, plasticizers, thixotropy agents, and the like by means of a batch type biaxial kneader or the like; subsequently, the aforementioned amine-adduct type latent hardener (B) and the aforementioned moisture latent hardener (C) are blended thereto optionally together with coupling agents, moisture absorbing agents, UV absorbing agents, solvents, curing catalysts, and other additives, if necessary; the mixture is further mixed and defoamed; and thereby, the objective composition can be produced.

The one-part type heat-curable composition of the present invention exhibits superior adhesion properties, curing properties, coating tolerance, and the like, and for this reason, the composition can be suitably applied to uses including production steps with heat treatments. Therefore, the one-part type heat curable composition of the present invention can be preferably employed as a component of sealing products, adhesives, or the like for use in automobiles, household electric goods, civil engineering and construction work, and the like.

### EXAMPLES

In the following, the present invention is described based on Examples and Comparative Examples.

### Example 1

In a batch type biaxial kneader, 24.4 parts of a prepolymer having isocyanate groups derived from isophorone diisocyanate (IPDI) at two end positions and a urethane bond, obtained by a reaction between polypropylene glycol and an excess of IPDI, and 13.0 parts of a thixotropy agent (a polyurea compound) are placed at room temperature. In addition, 32.2 parts of heavy calcium carbonate (NS-2100, produced by Nitto Funka Kogyo Co., Ltd.), 0.4 parts of titanium oxide (TCR-10, produced by Sakai Chemical Industry Co., Ltd.), 0.1 parts of a moisture latent hardener (ALD-1, produced by Mitsui Takeda Chemicals Inc.), 1.5 parts of an amine-adduct type latent hardener (Adeka Hardener EH 4070S, produced by Asahi Denka Corporation), and 1.5 parts of a solvent (xylene) were added thereto. Subsequently, the mixture was stirred and kneaded under vacuum conditions, and then defoamed. Thereby, a one-part type heat-curable urethane-based composition was produced.

### Example 2

A one-part type heat-curable urethane-based composition was obtained in the same manner as described in Example 1, with the exception that the blending amount of the amine-adduct type latent hardener was 0.5 parts.

### Comparative Example 1

A one-part type heat-curable urethane-based composition was obtained in the same manner as described in Example 1, with the exception of adding no amine-adduct type latent hardener.

### Comparative Example 2

A one-part type heat-curable urethane-based composition was obtained in the same manner as described in Example 1, with the exception of adding no moisture latent hardener.

Each of the compositions according to Examples 1 and 2 and Comparative Examples 1 and 2 was subjected to evaluation tests for “heat curing properties at high temperature”, “moisture curing properties after being heat-cured at low temperature”, “coating film adhesion properties”, and “slump properties”.

### Heat Curing Properties at High Temperature

Evaluation of heat curing properties was carried out in the manner as described below. The composition was applied in the form of a bead on a tin plate. Subsequently, the composition was cured by heating for 30 minutes at a baking temperature of 140° C. The cured conditions of the cured composition were visually observed. In the visual observation, the cured composition was cut by a cutter knife, and in the case of observing that the composition was uniformly cured from the surface to the inner part, the evaluation was ◯; and in the case of observing that the composition was not cured, evaluation was ×.

Moisture Curing Properties after being Heat-Cured at Low Temperature

On the assumption in that the heat curing was not sufficient, each of the compositions according to Examples 1 and 2 and Comparative Examples 1 and 2, as well as a one part-type epoxy-based adhesive (Sika Power 430, produced by Sika AG Co., Ltd.) as Comparative Example 3 employed in the assembling automobile bodies in the automobile manufacturing lines, was heated for 30 minutes at 80° C. which was relatively low temperature. Subsequently, the composition was subjected to moisture-curing under an atmosphere of a temperature of 20° C. and a humidity of 65%. After 48 hours, the cured conditions of the cured composition (inner cured thickness=3 mm) were visually observed. In the visual observation, the cured composition was cut by a cutter knife, and in the case of observing that the composition was cured from the surface to the inner part, the evaluation was ◯; in the case of observing semi-cured conditions (inner curing was insufficient), the evaluation was Δ; and in the case of observing that the composition was not cured, the evaluation was ×.

### Coating Film Adhesion Properties

Evaluation of coating film adhesion properties was carried out in accordance with JIS K5400⁻¹⁹⁹⁰ “general coating test method”. In particular, the composition was applied onto a tin plate so that the thickness of the applied composition ranged from about 2 to 3 mm. Subsequently, a melamine alkyd paint was applied thereto, and baking for 30 minutes at 140° C. was carried out, followed by drying. The baked and dried product was cut by a cutter knife, and a peeling evaluation was carried out by means of Cellophane® tape. In the case of exhibiting superior adhesiveness between the surface of the composition and the coating film, evaluation was ◯ (>75%); in the case of exhibiting fair adhesiveness, evaluation was Δ (30% to 75%); and in the case of exhibiting poor adhesiveness, evaluation was × (<30%).

### Slump Properties

Evaluation of slump properties was carried out in accordance with JIS A5758⁻¹⁹⁹² “4.3 Slump test” in “Sealing products for use in construction”. In particular, three groove-shaped containers for use in slump tests (made of corrosion-resistance metal, thickness=about 1 mm) were prepared. Each of the containers was rapidly charged with the composition so that bubbles were not present in the composition. Subsequently, the surface of the composition was smoothed. Subsequently, the containers were vertically suspended for 30 minutes in a thermostatic chamber at 140° C. Subsequently, the distance from the lower end of the groove part of the groove-shaped container to the front end of the composition running down from the lower end of the groove part was measured. The measurement value was used as a slump (longitudinal) value (mm). As the slump value is reduced, the composition exhibits better thixolabile properties. Here, in the case of a slump value of 0.5 mm or less, the evaluation was ◯.

The results are shown in Table 1. The values for the composition in the table are based on parts by weight.

TABLE 1

| | | | | Comparative | Comparative | Comparative |
|---|---|---|---|---|---|---|
| | | Example 1 | Example 2 | Example 1 | Example 2 | Example 3 |
| Composition | Prepolymer | 24.4 | 24.4 | 24.4 | 24.4 | |
| | Amine-adduct type | 1.5 | 0.5 | — | 1.5 | |
| | latent hardener | | | | | |
| | Moisture latent | 0.1 | 0.1 | 0.1 | — | |
| | hardener | | | | | |
| | Thixotropy agent | 13.0 | 13.0 | 13.0 | 13.0 | |
| | Titanium oxide | 0.4 | 0.4 | 0.4 | 0.4 | |
| | Heavy calcium | 32.2 | 32.2 | 32.2 | 32.2 | |
| | carbonate | | | | | |
| | Solvent | 1.5 | 1.5 | 1.5 | 1.5 | |
| Physical | Heat curing properties | ∘ | ∘ | x | ∘ | — |
| properties | at high temperature | | | | | |
| | Moisture curing | ∘ | ∘ | ∘ | Δ | x |
| | properties after being | | | | | |
| | heat-cured at low | | | | | |
| | temperature | | | | | |
| | Coating adhesion | ∘ | Δ | x | x | — |
| | properties | | | | | |
| | Slump properties | ∘ | ∘ | ∘ | ∘ | — |

1. A one-part type heat-curable composition comprising:
(A) a prepolymer having a urethane bond(s), and an isocyanate group(s) at a chain end(s) or a pendent position(s) thereof;
(B) an amine-adduct type latent hardener; and
(C) a moisture latent hardener

2. The composition according to claim 1, wherein the prepolymer (A) comprises a polyether structure(s).

3. The composition according to claim 1, wherein the content of the prepolymer (A) is 15 to 80 wt % relative to the total weight of the composition.

4. The composition according to claim 1, wherein the content of the amine-adduct type latent hardener (B) is 0.1 to 10 wt % relative to the total weight of the composition.

5. The composition according to claim 1, wherein the content of the moisture latent hardener (C) is 0.1 to 10 wt % relative to the total weight of the composition.

6. A sealing product or an adhesive comprising the composition of claim 1.
